(19) United States
(12) Patent Application Publication
(10) Pub. No.: US 2013/0116994 A1
(43) Pub. Date: May 9, 2013

(54) WATER MANAGEMENT

(71) Applicants: Ian Abbott Donnelly, Stamford (GB); Rick A. Hamilton, II, Charlottesville, VA (US); Brian M. O'Connell, Durham, NC (US); Ralph P. Williams, Danville, CA (US)

(72) Inventors: Ian Abbott Donnelly, Stamford (GB); Rick A. Hamilton, II, Charlottesville, VA (US); Brian M. O'Connell, Durham, NC (US); Ralph P. Williams, Danville, CA (US)

(73) Assignee: International Business Machines Corporation, Armonk, NY (US)

(21) Appl. No.: 13/288,304

(22) Filed: Nov. 3, 2011

(51) Int. Cl. G06G 7/48

(52) U.S. Cl. 703/6

(57) ABSTRACT

Providing water management services includes generating a water accounting model. The model is generated by selecting data, via a user interface implemented by a computer processor, from options including water quality, water quantity, and water usage. The model is further generated by defining, via the user interface, parameters of the data for a geographic region, and defining, via the user interface, actions to be taken. Providing the water management services further includes mapping communications addresses of data sources of data selected via the user interface to the water accounting model, receiving input values for the data via the communications addresses from the data sources, executing the water accounting model, and identifying and implementing an action responsive to results of executing the mode.

### BACKGROUND

The present invention relates to water management, and more specifically, to integrated water-quality and usage metrics in a water accounting system.

Water quality can vary in many respects, depending on contexts such as potential applications and regional needs. Furthermore, water quality can change quickly either in temporal or spatial terms. For instances, a sudden, heavy rainfall may result in flooding and a corresponding rise in bacterial content of a given watershed. Alternatively water flow passing an outflow source may change from some relatively pristine source to a dangerously polluted body within a few meters. Such factors affecting water quality are many, and include pathogen content, heavy metal contaminants, salinization levels, and numerous other elements. In addition, the uses to which water is put combined with the effect on quality can have a large impact on its value in a catchment and regional context. The combination of domestic, industrial, agricultural, and ecosystem uses of water is vital to consider when accounting for water.

### SUMMARY

According to one embodiment of the present invention, a method for providing water management services. The method includes generating a water accounting model. The model is generated by selecting data, via a user interface implemented by a computer processor, from options including water quality, water quantity, and water usage. The model is further generated by defining, via the user interface, parameters of the data for a geographic region, and defining, via the user interface, actions to be taken. The method further includes mapping communications addresses of data sources of data selected via the user interface to the water accounting model, receiving input values for the data via the communications addresses from the data sources, executing the water accounting model, and identifying and implementing an action responsive to results of executing the mode.

According to another embodiment of the present invention, a system for providing water management services is provided. The system includes a host system computer and logic executable by the host system computer. The logic is configured to implement a method. The method includes generating a water accounting model. The model is generated by selecting data from options including water quality, water quantity, and water usage. The model is further generated by defining parameters of the data for a geographic region, and defining actions to be taken. The method further includes mapping communications addresses of data sources of data selected to the water accounting model, receiving input values for the data via the communications addresses from the data sources, executing the water accounting model, and identifying and implementing an action responsive to results of executing the mode.

According to a further embodiment of the present invention, a computer program product for providing water management services is provided. The computer program product includes a storage medium embedded with program instructions, which when executed by a computer cause the computer to implement a method. The method includes generating a water accounting model. The model is generated by selecting data from options including water quality, water quantity, and water usage. The model is further generated by defining parameters of the data for a geographic region, and defining actions to be taken. The method further includes mapping communications addresses of data sources of data selected to the water accounting model, receiving input values for the data via the communications addresses from the data sources, executing the water accounting model, and identifying and implementing an action responsive to results of executing the mode.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a system upon which water management services may be implemented according to an embodiment of the present invention;

FIG. 2 depicts a block diagram illustrating functional components of the water management services according to an embodiment of the present invention;

FIG. 3 depicts a flow diagram describing a process for implementing the water management services according to an embodiment of the present invention; and

FIG. 4 depicts a user interface screen illustrating water quantity aspects used by the water management services according to an embodiment of the present invention.

### DETAILED DESCRIPTION

According to an exemplary embodiment, water management services are provided. The water management services provide the ability to collect data for various water-related metrics regarding water quantity, quality, and usage in a water management system. The data is captured by data sources and transmitted to a collection system. The collection system includes a user interface component for enabling authorized users to set preferences used in configuring the data sources and control systems employed in the water management services, as well as generating and executing water management models, performing analysis on the histories of previously implemented models, and facilitating the generation of new models, or evolvement of existing models, to increase the ability for water treatment entities to ensure high water quality, as well as to maintain sufficient water levels needed by a community. Management logic executing on the collection system utilizes the information acquired from execution of the models to analyze and adopt price points for water consumption of the community of users.

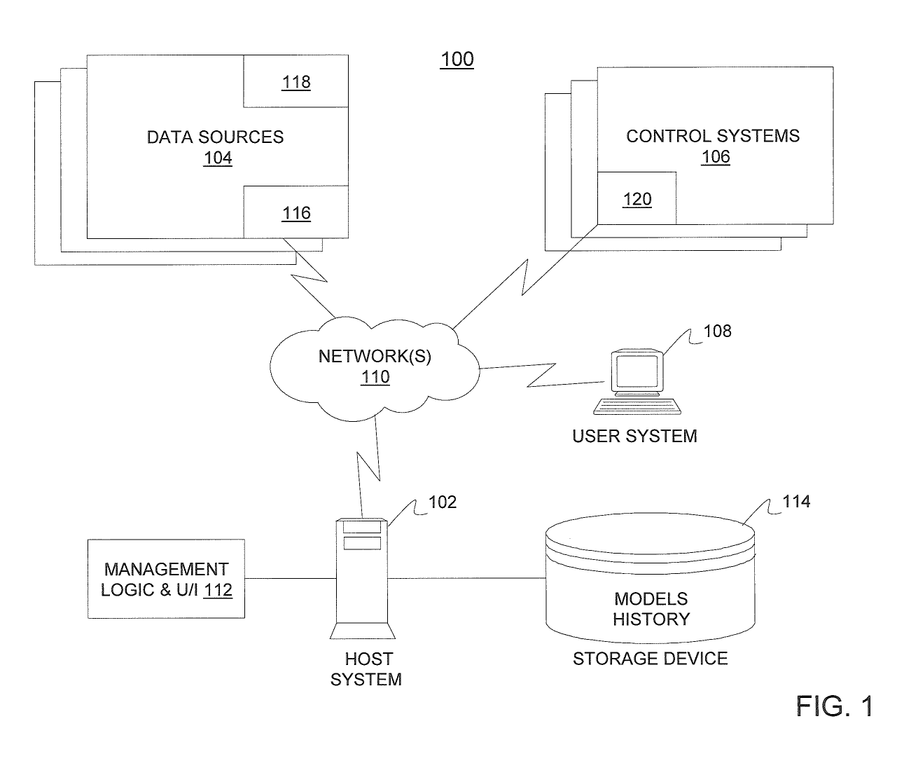

Turning now to FIG. 1, a system 100 upon which the water management services may be implemented will now be described in an exemplary embodiment. The system 100 of FIG. 1 includes a host system 102 in communication with data sources 104, control systems 106, and a user system 108 over one or more networks 110.

The host system 102 may be implemented as a high-speed computer processing device (e.g., a mainframe computer) that is capable of handling a large volume of activities conducted by the users of the water management services. The host system 102 may be implemented by a water management agency (e.g., a water treatment facility or government agency) or may be offered as a service to such agencies by an application service provider (ASP) entity. In an exemplary embodiment, the host system 102 performs data collection of various water-related metrics for the water management agency, as will be described further herein.

In one embodiment, the data sources 104 refer to devices or equipment that capture raw data from water sources. For example, the data sources 104 may include probes, sensors, and other instrumentation (not shown) that are located in proximity of the water sources and are configured to measure qualitative aspects of the water sources, such as microbes, bacteria, turbidity, saline content, chemicals, pathogens, and temperature, to name a few. The water sources may include a reservoir, basin, river, etc.

The data sources 104 may also include communication components 116 for transmitting data over one or more networks. In an embodiment, the communication components 116 may include, e.g., transceivers, antennae, and/or network cards for receiving and conveying data using wireless and/or wireline transmission technologies including WiFi, Bluetooth, cellular, satellite, copper wiring, co-axial cabling, etc. For example, a probe on a data source 104 collects data from a water source and transfers the data to the communication components 116 for transmission over networks 110 to the host system 102. In an embodiment, the data captured by the data sources 104 may be transmitted as raw data to the host system 102 or may be processed prior to transmission. The data sources 104 may also include a computer processor 118 for processing the raw data and/or formatting the data for transmission over the networks 110. Alternatively, if the data sources 104 do not include a computer processor, the captured data may be transmitted via the communication components 116 to a computer processor configured for receiving the data.

In another embodiment, some of the data sources 104 may alternatively include other information sources, such as portable communication devices (e.g., cellular telephones, smart phones, or other portable devices) operated by users who are in direct observation of the water sources or who have observed an event that may have an impact on water quality or quantity. The data collected by the host system 102 from these portable devices may include texts, images, messages, or other information provided by a user of a communication device. For example, an observer near a water source may witness a previously unreported substance in the water source, record an image of the substance, and transmit the image with date/time information, and alternatively a text description, to the host system 102 or another entity which forwards the information to the host system 102.

In a further embodiment, the data sources 104 may include a remote satellite that captures data relating to a water source (e.g., visual data indicative of water quantity).

The control systems 106 manage and control the operation of various water-related systems. For example, a control system 106 may include an electronic switch, activation/deactivation controls, or other element that, when engaged, performs a function with respect to the containment, flow, filter, and/or composition of water at a water source. For example, a control system 106 may include a switch that activates or deactivates a pump at a water treatment plant. Another control system 106 may engaged to increase or decrease the flow of water through a channel or from one location to another. A further example of a control system 106 includes a component that releases an additive, such as chlorine, to enhance water quality. It will be understood that the above examples are provided for illustrative purposes and are not to be construed as limiting in scope.

In an embodiment, the control systems 106 are communicatively coupled to communication components 120 similar to those described above with respect to the data sources 104. The controls systems 106 receive instructions from the host system 102 via the communication components 120 to modify an operation with respect to a water source, as will be described herein.

The networks 110 may include any type of networks, such as local area networks, wide area networks, virtual private networks, and the Internet. In addition, the networks 110 may be configured to support wireless communications, e.g., via cellular networks, satellite networks, and global positioning systems.

The host system 102 executes management logic 112 for implementing the exemplary water management services described herein. The management logic 112 includes a user interface component for enabling authorized users to set preferences used in configuring data sources 104 and control systems 106 employed in the water management services, as well as generating and executing water management models, performing analysis on the histories of previously implemented models, and facilitating the generation of new models, or evolvement of existing models, to increase the ability for water treatment entities to ensure high water quality, as well as to maintain sufficient water levels needed by a community. The management logic 112 may also be configured to utilize the information acquired from execution of the models to analyze and adopt price points for water consumption of the community of users. These, and other features of the water management services, will be described further herein.

The host system 102 is communicatively coupled to a storage device 114 that stores various data used in implementing the water management services. For example, the storage device 114 may store management models, performance histories, and other information desired. The storage device 114 may be directly in communication with the host system 102 (e.g., via cabling) or may be logically addressable by the host system 102, e.g., as a consolidated data source over one or more networks 110.

The user system 108 may be implemented as a general purpose computer, such as a desktop computer or laptop. The user system 108 may access the user interface of the management logic 112 from the host system 102 over the networks 110 to generate and run models, review performance histories, and perform analyses. The user system 108 may be operated by a representative of the host system 102 or end user of the water management services.

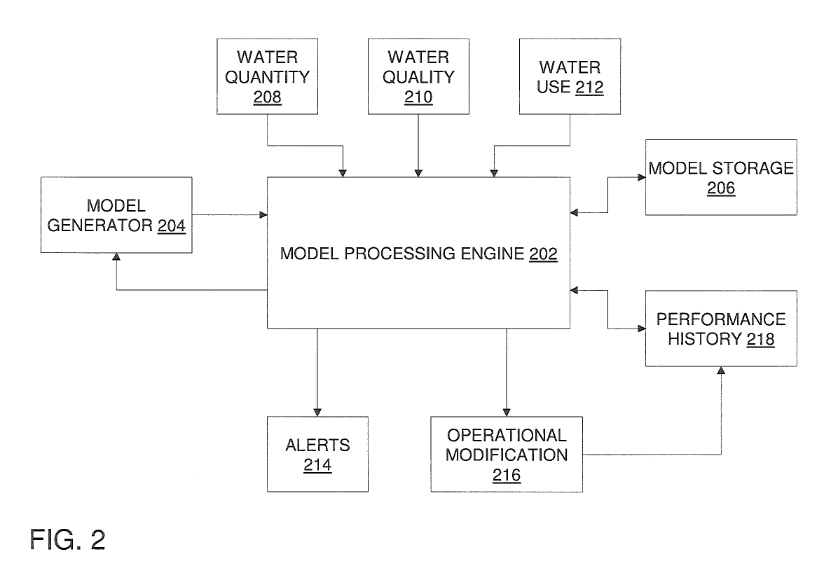

Turning now to FIG. 2, various functional components of the water management services will now be described in an exemplary embodiment. The functional components include a model processing engine 202, a model generator 204, and stored models 206 components. A user creates a model via the model generator 204, which may be implemented by the user interface of the management logic 112 and user system 108. The created model may be stored as one of several stored models 206, e.g., in the storage device 114 of FIG. 1. The model processing engine 202 receives data inputs relating to water quantity 208, water quality 210, and water use 212. The data inputs relating to water quantity 208 may come from the data sources 104 (e.g., physical in-situ sensors or remote satellite sensing). The water quantity information may be captured and stored by cubic meter or similar measure. The data inputs relating to water quality 210 may come from the data sources 104. The data inputs relating to the water use 212 may come from specific use metering or computer models that estimate usage based on a range of related measures and proxies. The water use 212 information may include a breakdown of the nature of use of a water source by a community. For example, 10% of the water is used domestically by the community's citizens, 30% is used for agriculture, 40% of the water sustains the community's ecosystem, and 20% of the water is lost due to evaporation, transpiration, and lack of containment (e.g., to the ocean).

The model processing engine 202 applies a model created via the model generator 204 to the data inputs. The model processing engine 202 may be implemented by a computer processing unit of the host system 102, as well as the management logic 112. Results of applying the model to the inputs may be stored by a performance history component 218 (e.g., in the storage device 114 of FIG. 1).

The functional components also include an alerts component 214 and an operation modification component 216. The management logic 112 may be configured by a user via the user interface to identify conditions for which alerts will be generated. For example, if a data input from a data source 104 indicates that a microbe level reaches a specified threshold, an alert is generated and transmitted to a specified entity or individual. When a user is in the process of creating a model, this alert information can be provided, as will be described further herein. The model processing engine 202 generates alerts based on results of the model execution. In another embodiment, management logic 112 may be configured by a user via the user interface to identify conditions for which operational modifications will be made. The operational modification component 216 drives the control systems 106 via the model processing engine 202 to modify various operations with respect to a water source in response to execution of the model.

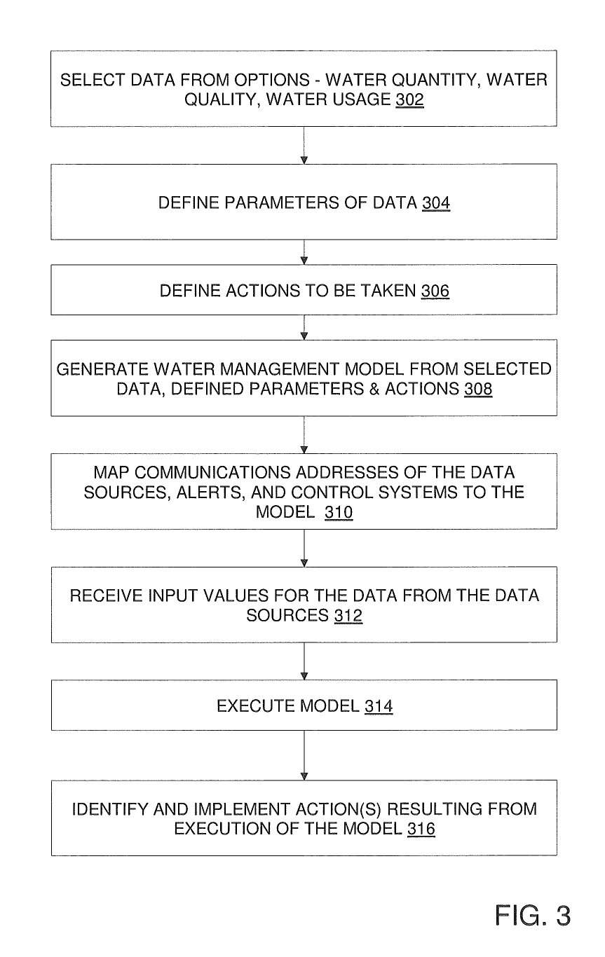

Turning now to FIG. 3, a flow diagram describing a process for implementing the water management services will now be described in an exemplary embodiment. In one embodiment, the services provide a web-based user interface for receiving information from a user in creating and implementing a model. Once accessed, the user interface, via the management logic 112, prompts a user through the process.

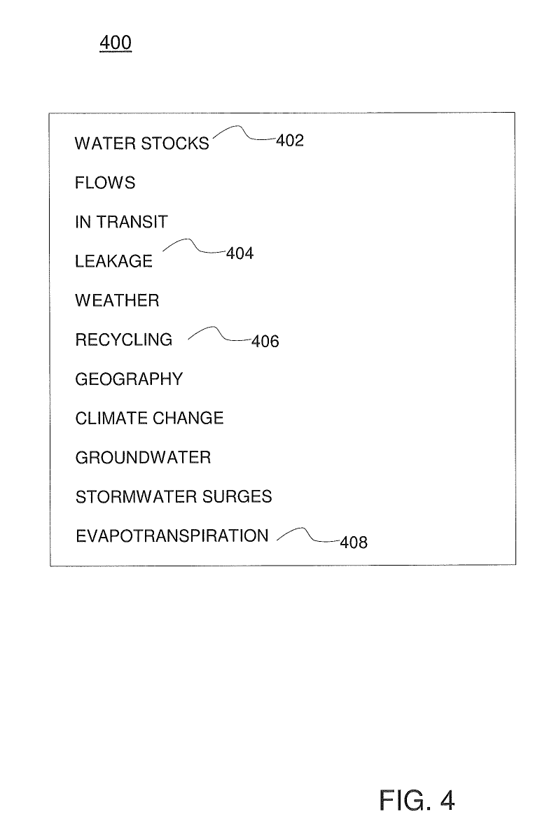

At step 302, the user selects or enters the data to be used by the model. For example, FIG. 4 illustrates aspects or events that relate to water quantity. The user may select one or more of the options, which when selected cause the management logic 112 to request additional information depending on the selection. For example, a current volume of water in a water source may be entered for “Stocks” 402. In another example, a user may select “Leakage” 404, “recycling” 406, and “evapotranspiration” 408 and enter the amount or percent of water that is lost due to leakage events and evapotranspiration, as well as the amount or percentage of water that is recycled. In addition to these examples, local conditions may define the nature and importance of other aspects of water quantity that need to be taken into account, such as flows (e.g., surface and groundwater flows), in transit water (e.g., pipe distribution), weather driven sources of water (e.g., rain, snow and storm surge), and broader influences on water quantity from surrounding geographies and global climate change.

In addition, at step 302, the user selects or enters data relating to water quality and use. With respect to water quality, the user may enter aspects of water that impact its quality. These aspects may be classified by chemical, biological, and physical qualities (e.g., turbidity).

At step 304, the user defines parameters of the data for the water source and/or a collection of water sources. For example, permissible ranges of additives, such as chlorine may be tracked by the data sources 104 and communicated to the host system 102. These ranges specify the parameters of this data element. Acceptable ranges for other elements, such as microbes, pathogens, bacteria, etc. may be defined as well. In an embodiment, some of these ranges may be pre-configured based on environmental or health regulations and laws. In this manner, a user may be permitted to re-define the parameters only to meet more stringent standards. The ranges set by the user may take into account the water use information designated for the water source. For example, if the water use is primarily for industrial applications, the need for high quality water may not be necessary as compared to domestic applications.

At step 306, the user may define actions to be taken when data input values are outside of the ranges specified by the user. These actions may include generating and transmitting alerts to designated individuals and/or may include initiating operational modifications to component of the water system. Alerts and operational modifications may be defined by providing an electronic address for the individual, entity, or relevant control system 106.

At step 308, the management logic 112 generates a model from the selected data, defined parameters, and actions described above.

At step 310, the management logic 112 maps communications addresses of the data sources 104, alert recipients, and control systems 106 to the model.

At step 312, the management logic 112 receives input values for the data from the data sources 104 configured by the user.

At step 314, the model is executed with respect to the data inputs. The management logic 112 identifies the corresponding data sources 104 of the data inputs. For example, the management logic 112 may identify a data source 104, e.g., via an IP address or identifier, selected by the user via the user interface, and associate a data input indicative of a positive identification of a chemical in the water source.

At step 316, the management logic 112 identifies and implements an action based on the results of executing the model. For example, the management logic 112 generates an alert and/or initiates an operational modification.

The model may be stored in the storage device 114 along with performance histories of the results of model execution for analytical purposes. The management logic 112 may be configured to perform trend analysis, assess ownership/rights management, model future scenarios, assess social awareness (e.g., how humans use and impact water), create a geographic dashboard showing locations in a water system (e.g., basins, flows, holding facilities) and their statuses, and generating a pricing model for water use.

Technical effects of the invention provide the ability to collect data for various water-related metrics regarding water quantity, quality, and usage in a water management system. The data is captured by data sources and transmitted to a collection system. The collection system includes a user interface component for enabling authorized users to set preferences used in configuring the data sources and control systems employed in the water management services, as well as generating and executing water management models, performing analysis on the histories of previously implemented models, and facilitating the generation of new models, or evolvement of existing models, to increase the ability for water treatment entities' to ensure high water quality, as well as to maintain sufficient water levels needed by a community. Management logic executing on the collection system utilizes the information acquired from execution of the models to analyze and adopt price points for water consumption of the community of users.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for providing water management services, the method comprising:
generating a water accounting model, comprising:
selecting data, via a user interface implemented by a computer processor, from options including water quality, water quantity, and water usage;
defining, via the user interface, parameters of the data for a geographic region; and
defining, via the user interface, actions to be taken;
mapping communications addresses of data sources of data selected via the user interface to the water accounting model;
receiving input values for the data via the communications addresses from the data sources, the data sources monitoring a water source;
executing the water accounting model; and
identifying and implementing an action responsive to results of executing the model.

2. The method of claim 1, wherein the parameters of the data include acceptable levels of additives in the water source, the acceptable levels defined by a threshold value.

3. The method of claim 2, wherein the acceptable levels of additives are defined as a function of the water use.

4. The method of claim 1, wherein the parameters of the data include acceptable levels of an element affecting water quality, the element comprising at least one of a microbe, pathogen, and bacteria, the acceptable levels of the element pre-configured to conform with environmental regulations.

5. The method of claim 4, wherein the acceptable levels of the element are defined as a function of the water use.

6. The method of claim 5, wherein the acceptable levels of the element are further defined as a function of the water quantity.

7. The method of claim 1, wherein the water use is classified by:
domestic application;
agricultural application; and
ecosystem application.

8. A system for providing water management services, the system comprising:
a host system computer; and
logic executable by the host system computer, the logic configured to implement a method, the method comprising:
generating a water accounting model, comprising:
selecting data from options including water quality, water quantity, and water usage;
defining parameters of the data for a geographic region; and
defining actions to be taken;
mapping communications addresses of data sources of data selected via the user interface to the water accounting model;
receiving input values for the data via the communications addresses from the data sources;
executing the water accounting model; and
identifying and implementing an action responsive to results of executing the model.

9. The system of claim 8, wherein the parameters of the data include acceptable levels of additives in the water source, the acceptable levels defined by a threshold value.

10. The system of claim 9, wherein the acceptable levels of additives are defined as a function of the water use.

11. The system of claim 8, wherein the parameters of the data include acceptable levels of an element affecting water quality, the element comprising at least one of a microbe, pathogen, and bacteria, the acceptable levels of the element pre-configured to conform with environmental regulations.

12. The system of claim 11, wherein the acceptable levels of the element are defined as a function of the water use.

13. The system of claim 12, wherein the acceptable levels of the element are further defined as a function of the water quantity.

14. The system of claim 1, wherein the data source is a remote satellite.

15. A computer program product for providing water management services, computer program product comprises a storage medium embodied with machine-readable program instructions, which when executed by a computer, cause the computer to implement a method, the method comprising:
generating a water accounting model, comprising:
selecting data from options including water quality, water quantity, and water usage;
defining parameters of the data for a geographic region; and
defining actions to be taken;
mapping communications addresses of data sources of data selected via the user interface to the water accounting model;
receiving input values for the data via the communications addresses from the data sources;
executing the water accounting model; and
identifying and implementing an action responsive to results of executing the model.

16. The computer program product of claim 15, wherein the parameters of the data include acceptable levels of additives in the water source, the acceptable levels defined by a threshold value.

17. The computer program product of claim 16, wherein the acceptable levels of additives are defined as a function of the water use.

18. The computer program product of claim 15, wherein the parameters of the data include acceptable levels of an element affecting water quality, the element comprising at least one of a microbe, pathogen, and bacteria, the acceptable levels of the element pre-configured to conform with environmental regulations.

19. The computer program product of claim 18, wherein the acceptable levels of the element are defined as a function of the water use.

20. The computer program product of claim 19, wherein the acceptable levels of the element are further defined as a function of the water quantity.
